(19) United States
(12) Patent Application Publication
(10) Pub. No.: US 2026/0334376 A1
(43) Pub. Date: Oct. 29, 2026

(54) PLANT GROWING SYSTEM FOR PROVIDING ELECTRICAL POWER TO ENHANCE GROWTH

(71) Applicant: XTRION AGRICULTURE INNOVATION LTD., Rahat (IL)

(72) Inventors: Roy WINTER, Zoran (IL); Assaf ZERAH, Zur Moshe (IL); Matan Emanuel ROSENFELD, Tel Aviv-Yafo (IL)

(73) Assignee: XTRION AGRICULTURE INNOVATION LTD., Rahat (IL)

(21) Appl. No.: 19/101,636

(22) PCT Filed: Aug. 8, 2023
(86) PCT No.: PCT/IL2023/050822

§ 371 Date: Feb. 6, 2025

Related U.S. Application Data
(60) Provisional application No. 63/395,909, filed on Aug. 8, 2022.

(51) Int. Cl. A01G 7/04; A01G 31/00

(52) U.S. Cl. CPC A01G 7/04; A01G 31/008

(57) ABSTRACT

A plant growing system is disclosed. The plant growing system comprising: a grow bed comprising a growth solution; an electrode assembly comprising: a power source connected between at least one solution electrode, being in electrical contact with said growth solution; and an array of plant electrodes electrically isolated from said growth solution, each plant electrode is configured to be electrically connected to at least one plant, planted in said grow bed; at least one sensor configured to measure an electric property of said growth solution; and a controller.

### CROSS REFERENCE TO RELATED APPLICATIONS

This application claims the benefit of priority under 35 U.S.C. § 119(e) of U.S. Provisional Patent Application No. 63/395,909, filed Aug. 8, 2022, entitled “PLANT GROWING SYSTEM FOR PROVIDING ELECTRICAL POWER TO ENHANCE GROWTH”. The contents of the above application is all incorporated by reference as if fully set forth herein in its entirety.

### FIELD OF THE INVENTION

The present invention relates generally to a plant growing system. More specifically, the present invention relates to a plant growing system for providing electrical power to enhance growth.

### BACKGROUND OF THE INVENTION

Enhancing or boosting plant growth with electricity utilizes the ability of electricity to aid the plants' growth in several ways. For example, the introduction of high-voltage kills all the virus-transmitting diseases and bacteria both in the soil and air. In yet another example, high-voltage wire suppresses the surface tension of water droplets on the plant leaves and accelerates evaporation.

Furthermore, the introduction of electricity accelerates transportation via diffusion) of some naturally charged particles such as calcium ions and bicarbonates, which boost the metabolism process of the plant. The latter is hard to control, requires connecting separately each plant to an electrode, and is therefore not widely used in large commercial greenhouses. Furthermore, as the plant grows, so does its root surface and therefore the electrical resistance of the plant. Therefore, the application of electrical power must follow up on the plant's growth. Additional variables such as growth medium temperature, humidity, nutrient concentration and plant type affect the application of electrical power.

Furthermore, it has been found that low frequency DC voltage pulses can be used to optimize the absorption of specific minerals, leveraging the resonance frequency of ions.

Therefore, there is a need for a reliable commercial system for providing electrical power to enhance growth that monitors the plant's growth and changes the provided electrical power in response.

### SUMMARY OF THE INVENTION

Some aspects of the invention may be directed to a plant growing system, comprising: a grow bed comprising a growth solution; an electrode assembly comprising: a power source connected between at least one solution electrode, being in electrical contact with said growth solution; and an array of plant electrodes electrically isolated from said growth solution, each plant electrode is configured to be electrically connected to at least one plant, planted in said grow bed; at least one sensor configured to measure an electric property of said growth solution; and a controller configured to:
(a) control said power source to provide a first electric power level to said at least one solution electrode and said plant electrodes;
(b) receive from said at least one sensor one or more measurements of said electric property of said growth solution;
(c) determine a second power level based on said one or more measurements; and
(d) control said power source to provide said second electric power level.

Some additional aspects of the invention may be directed to another plant growing system, comprising: a grow bed comprising a growth solution; at least one solution electrode, being in electrical contact with said growth solution; a drip irrigation system comprising an array of droppers, wherein each dropper continuously pours the growth solution to a location above the surface of the growth solution at the grow bed, in proximity to at least one plant planted in said grow bed; a power source electrically connected between the at least one solution electrode, and the drip irrigation system; at least one sensor configured to measure an electric property of said growth solution; and a controller configured to:
(a) control said power source to provide a first electric power level to said at least one solution electrode and said drip irrigation system;
(b) receive from said at least one sensor one or more measurements of said electric property of said growth solution;
(c) determine a second power level based on said one or more measurements; and
(d) control said power source to provide said second electric power level.

In some embodiments, the power source is connected to said drip irrigation system by one of: a conductive pipe or the growth solution poured by said drip irrigation system.

In some embodiments, the controller of each system is configured to repeat steps (b)-(d) at least once. In some embodiments, controlling said power source to provide the first and second power level includes setting a first duration for the provision of said first electric power level and a second duration for the provision of said second electric power level. In some embodiments, controlling said power source to provide the first and second power level includes setting a pause between the provision of said first electric power level and the provision of said second electric power level. In some embodiments, at least one of, the first electric power level and the second electric power level are between 0.1 mV to 24 V.

In some embodiments, the one or more measurements are received continuously with the provision of the electrical power. In some embodiments, said electric property is a voltage of said growth solution, and wherein the controller is configured to determine the second electric power level such that a substantially constant voltage level is maintained. In some embodiments, the controller is further configured to:
receive a type of plant planted in said grow bed; and
determined said first electric power level and said second electric power based on said type of plant.

In some embodiments, each of the systems further comprises a pH sensor being in contact with said growth solution and wherein said controller is further configured to determine said second power level based on pH measurements received from said pH sensor. In some embodiments, each of the systems further comprises a thermometer in contact with said growth solution and wherein said controller is further configured to determine said second power level based on temperature measurements received from said thermometer. In some embodiments, each of the systems further comprises a humidity sensor for measuring the humidity level in the vicinity of said at least one plant and wherein said controller is further configured to determine said second power level based on the humidity level.

In some embodiments, the grow bed is selected from: hypophonic grow bed, a raised bed comprising grow soil, field, and a flowerbed, for example, beds included in green house, screen houses, indoor farming facility and the like.

In some embodiments, the system may apply low frequency DC voltage pulses, influencing the resonance frequency of desired ions from grow bed and enhancing their uptake by the plants.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIGS. 1A and 1B are illustrations of plant growing systems according to some embodiments of the invention;

FIG. 1C is a block diagram of a plant growing system according to some embodiments of the invention;

FIG. 1D is an image of a nonlimiting example for a plant electrode according to some embodiments of the invention;

FIGS. 1E and 1F are an image and illustrations of a solution electrode and electrode assembly according to some embodiments of the invention;

FIG. 2 is a flowchart of a method of controlling a plant growing system according to some embodiments of the invention;

FIG. 3A is an illustration of another plant growing system according to some embodiments of the invention;

FIG. 3B is a block diagram of a plant growing system of FIG. 3A according to some embodiments of the invention;

FIG. 3C is a flowchart of another method of controlling a plant growing system according to some embodiments of the invention;

FIG. 4 is a graph of experimental results showing measurements of the growth solution potential vs. the age of the plants, according to some embodiments of the invention;

FIG. 5 is an image of an experimental setup of a plant growing system according to some embodiments of the invention; and

FIG. 6 shows images of plants that were cultivated in a hydroponic plant-growing system according to embodiments of the invention in comparison to plants that were cultivated in a commercial hydroponic grow bed.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of the same or similar features or elements may not be repeated.

Some aspects of the invention may be related to a system for at least one of, enhancing the growth of plants, enhancing the protection of the plants from pests, and diseases, increasing the plants' nutrients uptake and utilization, increasing other functional traits of the plants, such as, vitamin content, protein content, and the like. The system may provide a controlled amount of electrical power to the plants. In some embodiments, the system may be assembled or may include any grow bed that includes a growth solution. The system may follow the plant's growth/behavior, by monitoring an electrical property of the grow bed and/or the growth solution, and adapt the amount of provided power, according to the plant's type and/or the growth stage.

In some embodiments, the system may monitor the electrical property and may change the amount of electrical power provided to the plants based on the monitoring. The monitoring may be conducted continuously or periodically during the growth of the plant and therefore, the power level provided to the plants may change several times during the growth of the plant. For example, the power level may be changed twice a day, every day, once every 2-3 days, every week, every month and the like.

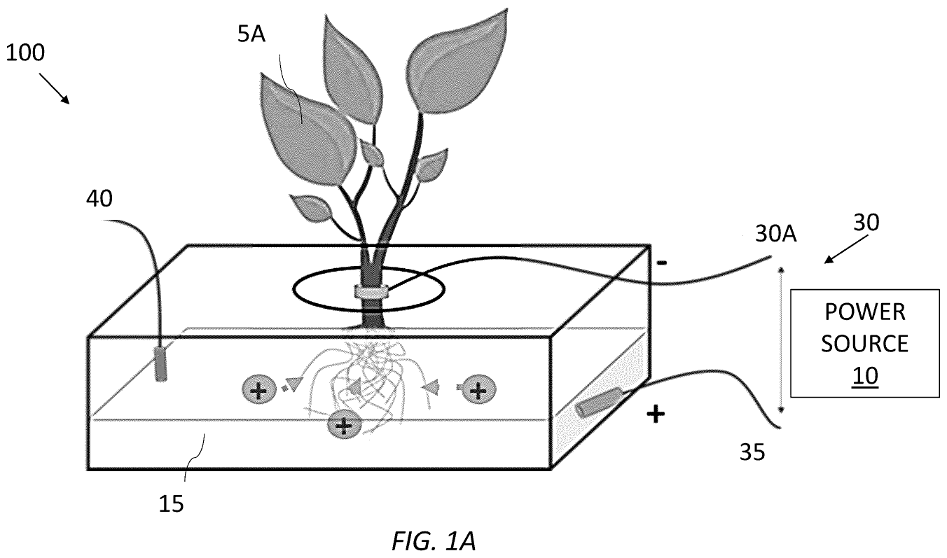

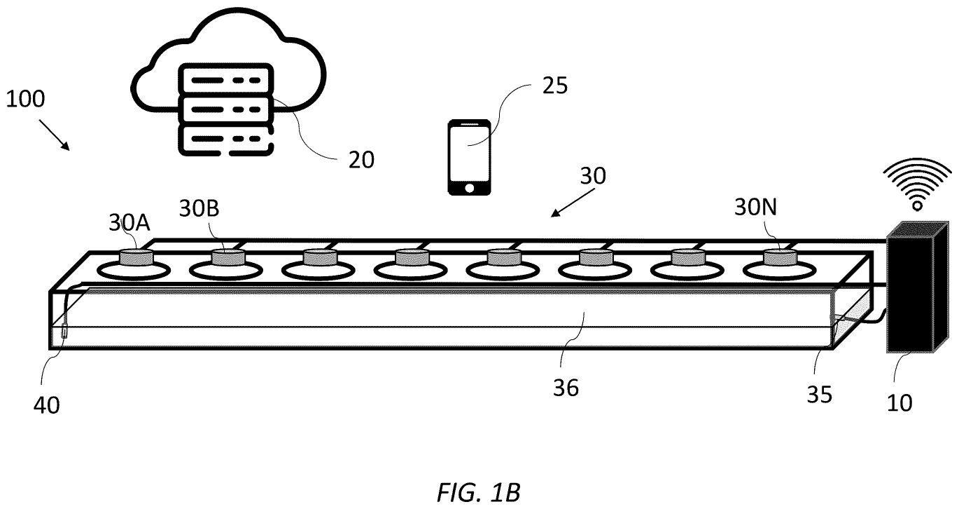

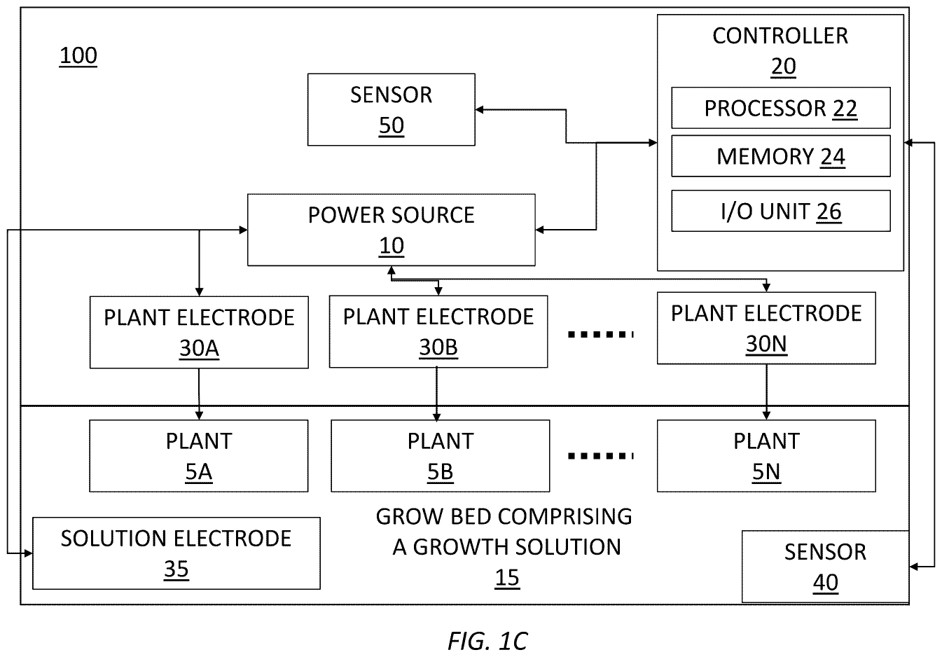

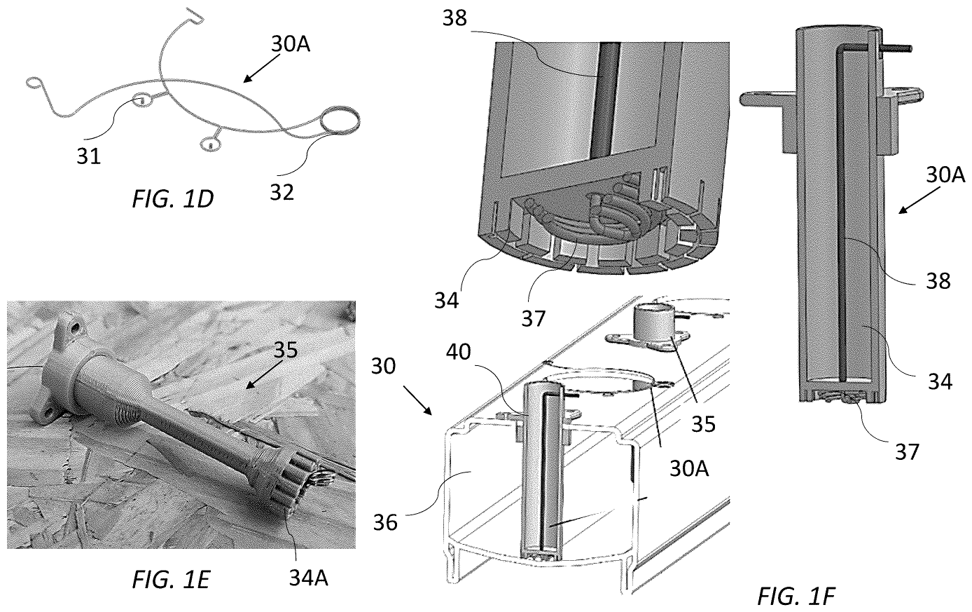

Reference is now made to FIGS. 1A, 1B, and 1C which are illustrations and a block diagram of a plant growing system according to some embodiments of the invention. A system 100 may include a grow bed 15 comprising a growth solution, an electrode assembly 30, and a controller 20.

Grow bed 15 may be any type of grow bed that is configured to hold a growth solution. Grow bed 15 may be a hydroponic grow bed, a raised bed comprising grow soil, a flowerbed, a field, and the like. In some embodiments, grow bed 15 may be a bed included in green house, screen houses, indoor farming facility and the like.

Plants 5A-5N planted in grow bed 15 may be any type of plant that is suitable to be raised in a growth bed. Some non-limiting examples for types of plants may include, tomatoes, corn, peppers, grapes, wheat, Buck Choi, mint, coriander, roman lettuce, red Selenova lettuce, green Selenova lettuce, basil, parsley, tarragon, and the like.

The growth solution may be any aqueous solution capable of providing solutes (e.g., salts, nutrients, fertilizers, etc.) to a plant in the grow bed. For example, the growth solution may be, the growth solution in a hydroponic bed, the humidity in a grow soil, the humidity in the soil of the flowerbed, the humidity in soil in the field, and the like. The growth solution may include any nutritive, fertilizer, or other salts required for growing the plants. The growth solution may be selected according to the type of the plants. In a non-limiting example, the growth solution may include macronutrients such as N, P, K, Ca, Mg, and S and also micronutrients such as B, Mn, Zn, Cu, Mo, Cl, Na and Fe (The concentration can vary depending on the strain).

Electrode assembly 30 may include a power source 10 connected between at least one solution electrode 35, being in electrical contact with the growth solution, and an array of plant electrodes 30A-30N electrically isolated from the growth solution. In some embodiments, at least plant electrodes 30A-30N may be supported by support 36. In some embodiments, each plant electrode 30A-30N is configured to be electrically connected to at least one plant 5A-5N, planted in grow bed 15. In the non-limiting example, illustrated in FIGS. 1A and 1B, plant electrodes 30A-30N are rings encompassing each plant 5A-5N. As should be understood by one skilled in the art, plant electrodes 30A-30N may have any suitable shape and can be connected to plants 5A-5N by any other connecting means (e.g., calps, stickers, etc.). A nonlimiting example for a design of electrode 30A and electrode assembly 30 is given with respect to FIGS. 1D and 1F.

In some embodiments, at least one solution electrode 35 may be located at any location inside grow bed 15 as long as a full electrical contact is maintained between at least a portion of solution electrode 35 and the growth solution during the entire operation time of system 100.

In some embodiments, system 100 may further include at least one sensor 40 configured to measure an electric property of said growth solution. Sensor 40 may be in full contact with the growth solution. For example, sensor 40 may include an additional electrode configured to measure the voltage (potential) of said growth solution. For example, sensor 40 may include an electrode located inside grow bed 15, an amperemeter, and a voltmeter and the like.

In some embodiments, system 100 may include at least one additional sensor 50. Sensor 50 may be selected from a pH sensor being in contact with said growth solution, a thermometer in contact with said growth solution, a humidity sensor for measuring the humidity level in the vicinity of said at least one plant 5A-5N and the like.

In some embodiments, controller 20 may include a processor 22 that may be, for example, a central processing unit (CPU) processor, a chip, or any suitable computing or computational device. Controller 20 may further include a memory 24 may be or may include, for example, a Random Access Memory (RAM), a read-only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 24 may be or may include a plurality of possibly different memory units. Memory 24 may be a computer or processor non-transitory readable medium, or a computer non-transitory storage medium, e.g., a RAM. In one embodiment, a non-transitory storage medium such as memory 24, a hard disk drive, another storage device, etc. may store instructions or code which when executed by processor 22 may cause the processor to carry out methods as described herein, for example, methods for controlling a plant growing system according to some embodiments of the invention.

In some embodiments, controller 20 may further include one or more input/output units 26. The input unit may be or may include any suitable input devices, components, or systems, e.g., a detachable keyboard or keypad, a mouse, and the like. The output unit may include one or more (possibly detachable) displays or monitors, speakers, and/or any other suitable output devices.

Controller 20 may be in direct communication either by wire or wirelessly (e.g., over the internet) with at least one user device 25. User device 25 may be a smartphone, a laptop computer, a tablet, a smartwatch, a desktop computer, and the like.

Reference is now made to FIG. 1D which is an image of a nonlimiting example for a plant electrode according to some embodiments of the invention. Electrode 30A was made from partially spiral metal, such as, stainless steel, titanium alloys, glassy carbon, platinum alloys, gold, and the like. In some embodiments, electrode 30A may include at least one connector 31 for connecting electrode 30A to support 36, as illustrated in FIG. 1F, and a spiral ring 32 configured to electrically be connected to at least one plant. In some embodiments, support 36 may ensure that electrode 30A is electrically isolated from the growth solution.

Reference is now made to FIGS. 1E and 1F which are an image and illustrations of a solution electrode and electrode assembly according to some embodiments of the invention. In the nonlimiting example of f FIGS. 1E and 1F plant solution electrode 35 may include a body 34 configured to hold a spiral electrode 37 electrically connected to a conductor 38 going through body 34 to be connected to power source 10. In some embodiments, body 34 may include perforated section 34A configured to allow flow of growth solution towards a spiral electrode 37 while protecting spiral electrode 37 from roots growing in the growth medium, which may cause shortcuts.

In some embodiments, support 36 may further support sensor 40 which may include an electrode located inside to be connected to an amperemeter, a voltmeter, and the like. At least one sensor 40 may have a substantially similar structure as solution electrode 35, or may have a different structure.

As should be understood by one skilled in the art the two plant electrodes 30A and solution electrode 35 illustrated are given as an example for a portion of electrode assembly 30, and the invention is not limited to any number of plant electrodes and solution electrodes.

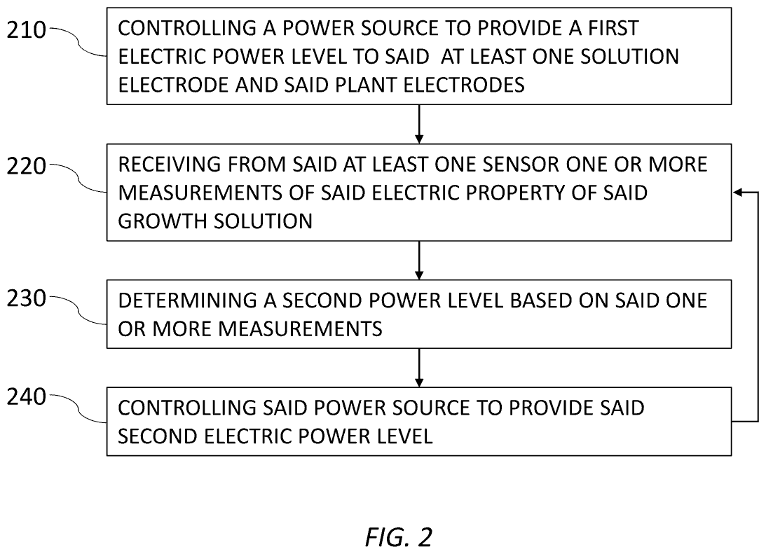

Reference is now made to FIG. 2 which is a flowchart of a method of controlling a plant growing system according to some embodiments of the invention. The method of FIG. 2 may be executed by a controller, such as controller 20 or by any other suitable controller.

In step 210, power source 10 may be controlled to provide a first electric power level to said at least one solution electrode 35 and said plant electrodes 30A-30B. The first electric power level may be determined based on at least one of, the number of plants, a type of plant planted in said grow bed, the concentration of nutrients in the solution, and the like.

In step 220, one or more measurements of said electric property of said growth solution may be received from at least one sensor 40. In some embodiments, at least one sensor 40 may measure the potential (e.g., the voltage) and/or the current of the solution. In some embodiments, one or more measurements are received continuously with the provision of the electrical power, such that the electric property of the growth solution is continuously being monitored. In some embodiments, one or more measurements are received periodically with the provision of the electrical power, for example, every constant number of minutes, e.g., every 5 min. 10 min, 20 min, 30 min, 1 hr., 6 hr., 12, hr. 24 hr. or any value in between.

In step 230, a second power level may be determined based on said one or more measurements. Controller 20 may determine the second power level to be substantially the same as the first power level. In some embodiments, controller 20 may determine the second power level to maintain a constant potential in the growth solution. The electric field between the plant roots and the growing medium decreases over time, due to the growth of the surface of the roots with the growth of the plant. In some embodiments, in order to maintain the effectiveness of nutrient diffusion/transformation from the solution to the plant, the outer field must be adapted to the changes in the roots. In some embodiments, second power level may be determined such as to cause an increase the effectiveness of fertilizers transformation from the solution to the plant.

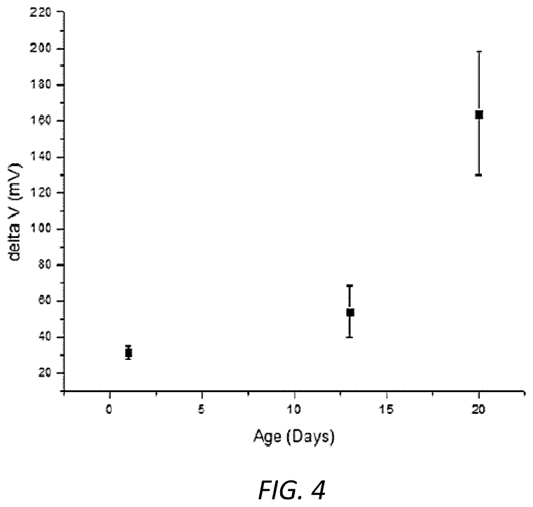

In some embodiments, the second power level may be determined such as to cause an increase in the potential (voltage level) to compensate for root growth, as shown in FIG. 4, where the solution potential was increased over time from 30 mV in day 1 to over 100 mV in day 20. Therefore, the second power level may be determined also based on the estimation of the root's volume/root's surface. In some embodiments, the second electric power level may be determined also based on at least one of, the number of plants, a type of plant planted in said grow bed, the concentration of nutrients in the solution, and the like.

In some embodiments, controller 20 may look at a lookup table, stored in memory 24, the lookup table may include various power levels associated with measurements of the electric property and the corresponding required results. For example, for a specific type of plants, the lookup table may include various measurements of the electric property, a required result (e.g., growth, increase the effectiveness of fertilizers and/or fertilizers, etc.) and a recommended second power level. The data in the lookup table may be collected experimentally, and/or may be calculated based on experimental data and/or agronomical data.

In step 240, power source 10 may be controlled to provide said second electric power level. In some embodiments, controller 20 is configured to repeat steps 720 to 740 at least once, for example, until the desired growth result is achieved.

In some embodiments, the method may further include controlling power source 10 to provide the first and second power levels including setting a first duration for the provision of said first electric power level and a second duration for the provision of said second electric power level. The first and/or second durations may be determined based on at least one of, the number of plants, a type of plant planted in said grow bed, the concentration of nutrients in the solution, and the like.

In some embodiments, controlling said power source to provide the first and second power level includes setting a pause between the provision of said first electric power level and the provision of said second electric power level. For example, the first power level may be provided for 5 days, then a pause of 8 hours may be provided followed by the provision of the second power level for 5 days.

In some embodiments, the method may further include determining the first and/or second power level based on pH measurements received from pH sensor 50. The pH level is indicative of the concentration of nutritive ions in the growth solution. In some embodiments, the method may further include determining the first and/or second power level based on temperature measurements received from temperature sensor 50. In some embodiments, the method may further include determining the first and/or second power level based on humidity measurements received from humidity sensor 50.

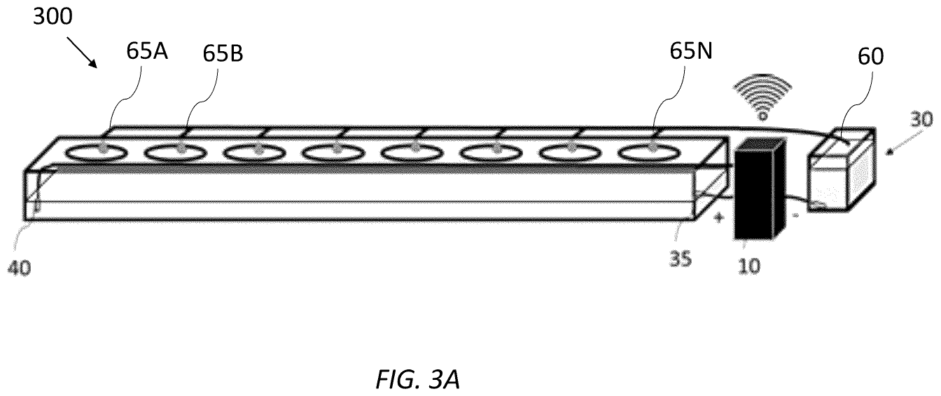

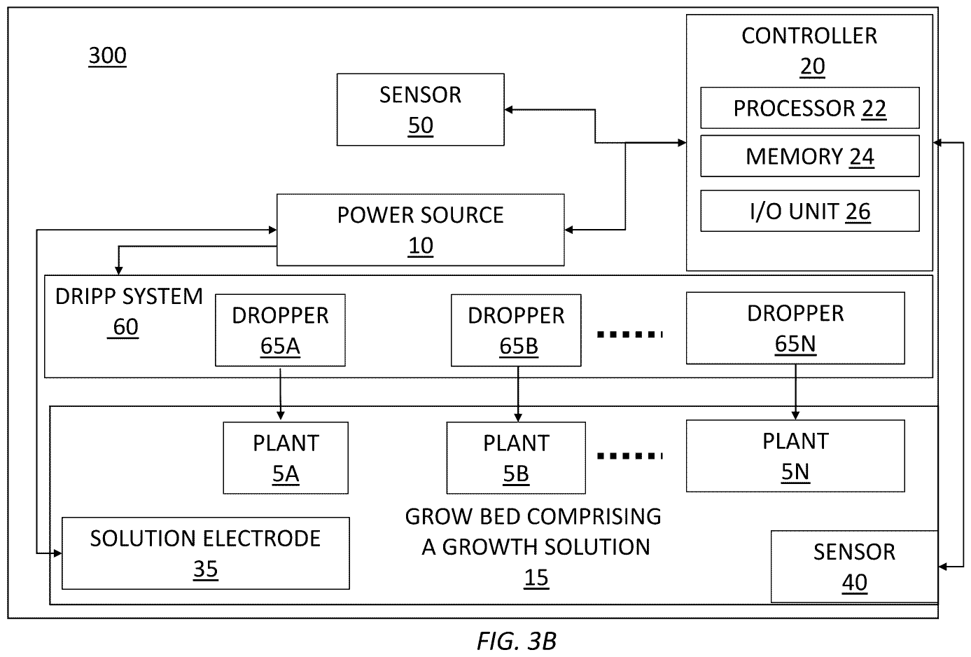

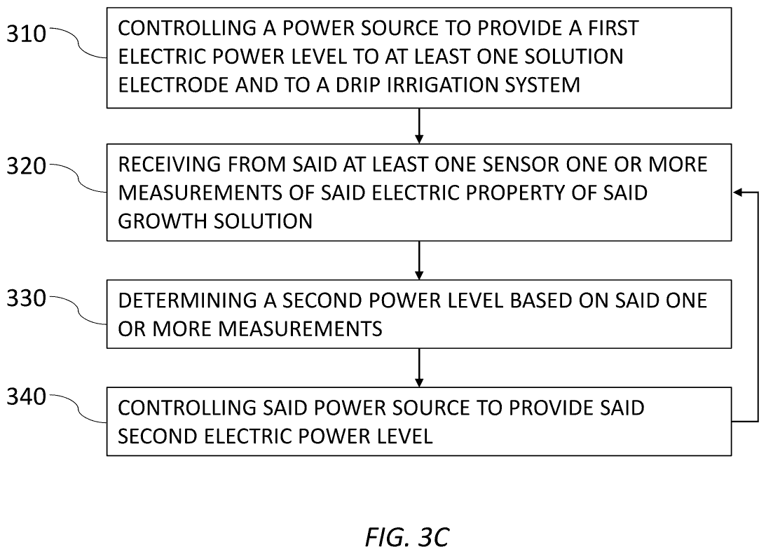

Reference is now made to FIGS. 3A and 3B which are illustrations and a block diagram of a plant growing system according to some embodiments of the invention. A system 300 may include a grow bed 15 comprising a growth solution, at least one solution electrode 35, being in electrical contact with said growth solution, a drip irrigation system 60 comprising an array of droppers 65, a power source 10, and a controller 20. In some embodiments, power source 10 is electrically connected between at least one solution electrode 35, and drip irrigation system 60.

Grow bed 15 may be any type of grow bed that is configured to hold a growth solution. Grow bed 15 may be a hydroponic grow bed, a raised bed comprising grow soil, a flowerbed, and the like. Plants 5A-5N planted in grow bed 15 may be any type of plant that is suitable to be raised in a good bed. Some non-limiting examples for types of plants may include, tomatoes, peppers, corn, grapes, wheat, Buck Choi, mint, coriander, roman lettuce, red Selenova lettuce, green Selenova lettuce, basil, parsley, tarragon, and the like. The growth solution may include any nutritive or other salts required for growing the plants. The growth solution may be selected according to the type of the plants. In a non-limiting example, the growth solution may include macronutrients such as N, P, K, Ca, Mg, and S and also micronutrients such as B, Mn, Zn, Cu, Mo, Cl, Na and Fe (The concentration can vary depending on the strain). Power source 10 may be any power source.

In some embodiments, power source 10 may be electrically connected to a conductive pipe included in drip irrigation system 60. Additionally or alternatively, power source 10 may be electrically connected directly to a reservoir of growth solution to be provided by droppers 65A-65N, as illustrated.

In some embodiments, at least one solution electrode 35 may be located at any location inside grow bed 15 as long as a full electrical contact is maintained between at least a portion of solution electrode 35 and the growth solution during the entire operation time of system 100.

In some embodiments, at all times droppers 65A-65N continuously pours the growth solution to a location above the surface of the growth solution at grow bed 15, optionally in proximity to each plant 5A-5N. In such a case, the electric circuit is closed due to ion conductivity in the growth solution.

In some embodiments, system 300 may further include at least one sensor 40 configured to measure an electric property of said growth solution. Sensor 40 may be in full contact with the growth solution. For example, sensor 40 may include an additional electrode configured to measure the voltage (potential) of said growth solution. For example, sensor 40 may include an electrode located inside grow bed 15, an amperemeter, and a voltmeter.

In some embodiments, system 300 may include at least one additional sensor 50. Sensor 50 may be selected from a pH sensor being in contact with said growth solution, a thermometer in contact with said growth solution, a humidity sensor for measuring the humidity level in the vicinity of said at least one plant 5A-5N, and the like.

Controller 20 of system 300 may be substantially the same as controller 20 of system 100.

Reference is now made to FIG. 3C which is a flowchart of a method of controlling a plant growing system according to some embodiments of the invention. The method of FIG. 2 may be executed by a controller, such as controller 20 of system 300 or by any other suitable controller.

In step 310, power source 10 may be controlled to provide a first electric power level to said at least one solution electrode 35 and said drip irrigation system 60. The first electric power level may be determined based on at least one of, the number of plants, a type of plant planted in said grow bed, the concentration of nutrients in the solution, and the like.

In step 320, one or more measurements of said electric property of said growth solution may be received from at least one sensor 40. In some embodiments, at least one sensor 40 may measure the potential (e.g., the voltage) and/or the current of the solution. In some embodiments, one or more measurements are received continuously with the provision of electrical power, such that the electric property of the growth solution is continuously being monitored. In some embodiments, one or more measurements are received periodically with the provision of the electrical power, for example, every constant number of minutes, e.g., every 5 min. 10 min, 20 min, 30 min, 1 hr., 6 hr., 12, hr. 24 hr. or any value in between.

In step 330, a second power level may be determined based on said one or more measurements. Controller 20 may determine the second power level to be substantially the same as the first power level. In some embodiments, controller 20 may determine the second power level to maintain a constant potential in the growth solution. The electric field between the plant roots and the growing medium decreases over time, due to the growth of the surface of the roots with the growth of the plant. In some embodiments, in order to maintain the effectiveness of nutrient diffusion/transformation from the solution to the plant, the outer field must be adapted to the changes in the roots.

In some embodiments, the second power level may be determined such as to cause an increase in the potential (voltage level) to compensate for root growth, as shown in FIG. 3, where the solution potential was increased over time from 30 mV in day 1 to over 100 mV in day 20. Therefore, the second power level may be determined also based on the estimation of the root's volume/root's surface.

In some embodiments, the second electric power level may be determined also based on at least one of, the number of plants, a type of plant planted in said grow bed, the concentration of nutrients in the solution, and the like.

In step 340, power source 10 may be controlled to provide said second electric power level. In some embodiments, controller 20 is configured to repeat steps 320 to 340 at least once, for example, until the desired growth result is achieved.

In some embodiments, the method may further include controlling power source 10 to provide the first and second power levels including setting a first duration for the provision of said first electric power level and a second duration for the provision of said second electric power level. The first and/or second durations may be determined based on at least one of, the number of plants, a type of plant planted in said grow bed, the concentration of nutrients in the solution, and the like. In some embodiments, at least one of, the first electric power level and the second electric power level are between 0.1 mV to 24 V. For example, the first electric power level and the second electric power level are between 0.1 mV to 1 mV, between 1 mV-10 mV, between 10 mV to 100 mV, between 100 mV to 1 V, between 1 V to 5 V, between 1 V to 10 V, between 5 V to 20 V, between 10 V to 24 V, and any value or range in between.

In some embodiments, the first electric power level and the second electric power level are provided as AC or DC electric powers. In some embodiments, the method may further include unique pulse protocol that uses low frequency DC voltage pulses to control the uptake of specific nutrients by plants. In a non-limiting example, the pulse protocol may increase uptake of specific macronutrients such as N, P, K, Ca, Mg, and S and also micronutrients such as B, Mn, Zn, Cu, Mo, Cl, Na and Fe.

In some embodiments, controlling said power source to provide the first and second power level includes setting a pause between the provision of said first electric power level and the provision of said second electric power level. For example, the first power level may be provided for 5 days, then a pause of 8 hours may be provided followed by the provision of the second power level for 5 days.

In some embodiments, the method may further include determining the first and/or second power level based on pH measurements received from pH sensor 50. The pH level is indicative of the concentration of nutritive ions in the growth solution. In some embodiments, the method may further include determining the first and/or second power level based on temperature measurements received from temperature sensor 50. In some embodiments, the method may further include determining the first and/or second power level based on humidity measurements received from humidity sensor 50.

### Experimental Results

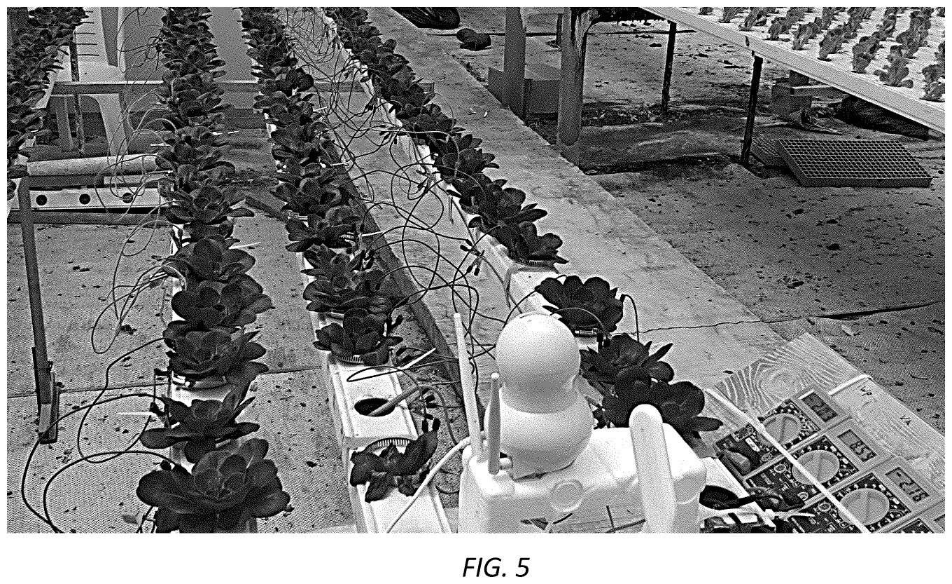

Several growth trials have been made in a hydroponic greenhouse using a hydroponic growth bed. An image of such a setup, growing red Selenova lettuce, is shown in FIG. 5. A 12 V power was provided to 400 plants, 100 reference plants were grown in a similar hydroponic growth bed without being connected to an electrode assembly.

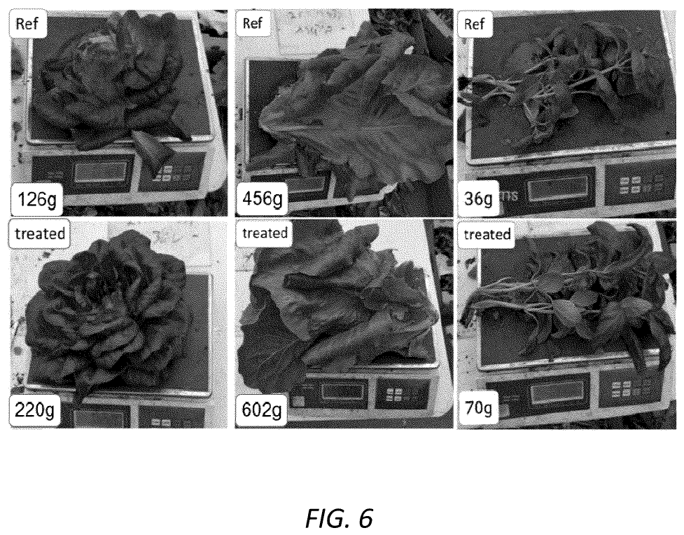

Reference is now made to FIG. 6 which shows images of plants that were cultivated in a hydroponic plant-growing system according to embodiments of the invention in comparison to plants that were cultivated in a commercial hydroponic grow bed. Basil, Selenova lettuce, and Roman lettuce (denoted as “treated”) were grown in the system of FIG. 5 and compared with Basil, Selenova lettuce, and Roman lettuce (denoted as “ref.”) grown in a similar commercial hydroponic growth bed. As clearly shown in the images, in addition to the increase in final volume and weight of each type of plant, an additional positive effect on the pests is demonstrated. The plants that were cultivated using the system of FIG. 4 were less affected by pests. The weight of the final product of the different plants was increased by about 30%-90% by using the electric field.

Additional experimental results of various plants cultivated using the system of FIG. 4 is listed in table 1.

TABLE 1
summarized experimental results for the average weight of various plants

| Type of plant | Ref. weight [gr.] | Treated weight [gr.] |
|---|---|---|
| Roman lettuce | 357 ± 5% | 439 ± 6% |
| Mint | 49 ± 11% | 66 ± 11% |
| Coriander | 213 ± 11% | 330 ± 8% |
| Basil | 16 ± 11% | 18 ± 8% |

Therefore, as shown by the results using system 100 according to embodiments of the invention increase the weight of the final product of the different plants by about 30%-90%.

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A plant growing system in grow bed, comprising:
an electrode assembly comprising:
a power source connected between at least one solution electrode, being in electrical contact with a growth solution; and
an array of plant electrodes electrically isolated from said growth solution, each plant electrode is configured to be electrically connected to at least one plant, planted in said grow bed;
at least one sensor configured to measure an electric property of said growth solution; and
a controller configured to:
(a) control said power source to provide a first electric power level to said at least one solution electrode and said plant electrodes;
(b) receive from said at least one sensor one or more measurements of said electric property of said growth solution;
(c) determine a second power level based on said one or more measurements; and
(d) control said power source to provide said second electric power level.

2. The system of claim 1, wherein said controller is configured to repeat steps (b)-(d) at least once.

3. (canceled)

4. The system of claim 1, wherein controlling said power source to provide the first and second power level includes setting a first duration for the provision of said first electric power level and a second duration for the provision of said second electric power level.

5. The system of claim 4, wherein controlling said power source to provide the first and second power level includes setting a pause between the provision of said first electric power level and the provision of said second electric power level.

6. The system of claim 1, wherein at least one of, the first electric power level and the second electric power level are between 0.1 mV to 24 V.

7. The system of claim 1, wherein at least one of, the first electric power level and the second electric power level are given as DC pulses.

8. The system of claim 1, wherein the one or more measurements are received continuously with the provision of the electrical power.

9. The system of claim 1, wherein said electric property is a voltage of said growth solution, and wherein the controller is configured to determine the second electric power level such that a substantially constant voltage level is maintained.

10. The system of claim 1, wherein the controller is further configured to:
receive a type of plant planted in said grow bed; and
determined said first electric power level and said second electric power based on said type of plant.

11. The system of claim 1, further comprising a pH sensor being in contact with said growth solution and wherein said controller is further configured to determine said second power level based on pH measurements received from said pH sensor.

12. The system of claim 1, further comprising a thermometer in contact with said growth solution and wherein said controller is further configured to determine said second power level based on temperature measurements received from said thermometer.

13. The system of claim 1, further comprising a humidity sensor for measuring the humidity level in the vicinity of said at least one plant and wherein said controller is further configured to determine said second power level based on the humidity level.

14. The system of claim 1, wherein the grow bed is selected from: hypophonic grow bed, a raised bed comprising grow soil and a flowerbed.

15. A plant growing system in a grow bed, comprising:
at least one solution electrode, being in electrical contact with a growth solution;
a drip irrigation system comprising an array of droppers in electrical connection to the power source, wherein each dropper continuously pours the growth solution to a location above the surface of the growth solution at the grow bed, in proximity to at least one plant planted in said grow bed;
a power source connected between the at least one solution electrode, and the drip irrigation system;
at least one sensor configured to measure an electric property of said growth solution; and
a controller configured to:
(a) control said power source to provide a first electric power level to said at least one solution electrode and said drip irrigation system;
(b) receive from said at least one sensor one or more measurements of said electric property of said growth solution;
(c) determine a second power level based on said one or more measurements; and
(d) control said power source to provide said second electric power level.

16. The system of claim 15, when the power source is connected to said drip irrigation system by one of: a conductive pipe or the growth solution poured by said drip irrigation system.

17. The system of claim 15, further comprising a grow bed comprising the growth solution.

18. The system of claim 15, wherein said controller is configured to repeat steps (b)-(d) at least once.

19. The system of claim 15, wherein controlling said power source to provide the first and second power level includes setting a first duration for the provision of said first electric power level and a second duration for the provision of said second electric power level.

20. The system of claim 19, wherein controlling said power source to provide the first and second power level includes setting a pause between the provision of said first electric power level and the provision of said second electric power level.

21. (canceled)

22. (canceled)

23. The system of claim 15, wherein the one or more measurements are received continuously with the provision of the electrical power.

24.-29. (canceled)
